(19) United States
(12) Patent Application Publication
(10) Pub. No.: US 2019/0201833 A1
(43) Pub. Date: Jul. 4, 2019

(54) AIR TREATMENT METHOD

(71) Applicants: Dow Global Technologies LLC, Midland, MI (US); Rohm and Haas Company, Collegeville, PA (US)

(72) Inventors: Michelle Gallagher, Cherry Hill, NJ (US); Chaofang Yue, Dublin, CA (US); Vikram Prasad, Midland, MI (US)

(21) Appl. No.: 16/332,803

(22) PCT Filed: Sep. 14, 2017
(86) PCT No.: PCT/US2017/051448

§ 371 Date: Mar. 13, 2019

Related U.S. Application Data
(60) Provisional application No. 62/400,776, filed on Sep. 28, 2016.

(51) Int. Cl. B01D 53/04; B01J 20/28; B01J 20/32; B01J 20/26

(52) U.S. Cl. CPC B01D 53/04; B01J 20/28021; B01J 20/321; B01J 20/327; B01D 2259/4508; B01J 20/261; B01D 2253/202; B01D 2253/25; B01D 2257/708; B01J 20/3293

(57) ABSTRACT

An air treatment method for removing a contaminant is provided, comprising: providing a for-treatment air containing the contaminant; providing a plurality of multi-staged non-film forming polymer particles having a core polymer and at least one shell polymer; wherein the core polymer accounts for 1 to 25 wt % of the weight of the non-film forming polymer particles provided; wherein the multi-staged non-film forming polymer particles provided each contain a central void; and contacting the multi-staged non-film forming polymer particles and the for-treatment air; wherein the contaminant is extracted from the for-treatment air producing a treated air depleted in the contaminant.

The present invention relates to an air treatment method for removing a contaminant. In particular, the present invention relates to an air treatment method, comprising: providing a for-treatment air containing the contaminant; providing a plurality of multi-staged non-film forming polymer particles having a core polymer and at least one shell polymer; wherein the core polymer accounts for 1 to 25 wt % of the weight of the non-film forming polymer particles provided; wherein the multi-staged non-film forming polymer particles provided each contain a central void; and contacting the multi-staged non-film forming polymer particles and the for-treatment air; wherein the contaminant is extracted from the for-treatment air producing a treated air depleted in the contaminant.

Air contamination in indoor spaces can take many forms including, for example, particulate matter (such as smoke and soot), biological agents (such as mold) and volatile organic compounds (VOCs). Some of the more common VOCs found in indoor spaces include benzene, toluene, acetaldehyde and trichloroethylene. Some VOCs are microbial in origin and are termed as microbial volatile organic compounds (mVOCs). Common examples include 3-octanone, 2-octen-1-ol, 1-butanol and 2-methyl-1-propanol.

Exposure to VOCs and mVOCs contaminants in indoor environments has been linked to multiple adverse health effects. Accordingly, the abatement of these volatiles can lead to improvement in public health and better quality of life. Treatment of indoor air to remove VOCs/mVOCs typically involves a combination of approaches such as removal of the source of the pollution, improving air distribution and treatment of the indoor air itself. One of the ways of treating air involves adsorption, wherein the contaminants are adsorbed on to materials such as activated carbon and zeolites. However, it is unclear whether these materials absorb VOCs/mVOCs effectively.

One method for air pollution abatement is disclosed by Kennedy in U.S. Pat. No. 3,798,876. Kennedy discloses a method of air pollution abatement substantially precluding dissipation into the ambient air of the vaporized organic compounds emitted by industrial plants, which comprises: (a) diverting industrial organic vapors from such plants into a mass or bed of macroreticular water insoluble cross linked polymer composed of 10 to 100 wt % of a polyvinyl methacrylate containing at least three methacrylate groups, wherein the balance of the polymer to make a 100 wt % is a monoethylenically or diethylenically unsaturated comonomer or derivatives of said polymer containing a group selected from the class consisting of sulfonic acid, amine oxide, quaternary ammonium amine, sulfoxide, amide, and ketone functionality; which polymer has a surface area of at least 10 to 1,000 m²/g, a porosity of at least 25% ranging up to 85% and pores of an average diameter of at least 20 angstroms ranging up to 20,000 angstroms; (b) contacting the loaded polymer with a reagent fluid to release substantially all of the adsorbed organics; and (c) directing the desorbed organics to a disposal other than by atmospheric discharge.

Another air purification apparatus including high temperature regenerated adsorbent particles is disclosed by Hayes in U.S. Pat. No. 4,863,494. Hayes discloses a method of filtering volatile organic compounds from an air stream wherein the method comprises the steps of: (a) forming a fluid bed of beads of substantially pure divinyl benzene wherein the beads have a surface area of about 700 m²/g or greater, a pore volume in the range of about 1.8 to 2.24 cc/g, at least 72% pores wherein more than half the pores are in the range of about 30 to about 95 angstroms; (b) directing a volatile organic compound in fluid flow through said bed while organic compounds are adsorbed out of the fluid flow; and (c) periodically regenerating the fluid bed by passing a purged fluid therethrough at temperatures elevated above ambient temperature but limited to not more than about 290° C.

Notwithstanding, there remains a need for improved air treatment methods for removing contaminants (particularly volatile odoriferous contaminants). In particular, there remains a need for improved air treatment methods designed for removing contaminants from confined spaces (e.g., dwelling places; passenger cabins in automobiles, buses, trains, aircraft; etc.).

The present invention provides an air treatment method for removing a contaminant, comprising: (a) providing a for-treatment air containing the contaminant, wherein the contaminant comprises at least one of acetaldehyde, d-limonene, an aromatic, a pyridine, a pyrazine, 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene; (b) providing a plurality of non-film forming polymer particles, wherein the non-film forming polymer particles provided are multi-staged particles comprising a core polymer and at least one shell polymer; wherein the core polymer accounts for 1 to 25 wt % of the weight of the non-film forming polymer particles provided; wherein the core polymer comprises, as polymerized monomer units, 50 to 100 wt %, based on the weight of the core polymer, of at least one type of monoethylenically unsaturated core monomer containing a single carboxylic acid group; wherein the at least one shell polymer comprises, as polymerized monomer units: 10 to 50 wt %, based on the weight of the at least one shell polymer, of at least one type of multiethylenically unsaturated shell monomer; and 50 to 90 wt %, based on the weight of the at least one shell polymer, of at least one type of monoethylenically unsaturated shell monomer; wherein the non-film forming polymer particles provided each contain a central void, wherein the non-film forming polymer particles provided have an average void fraction of 1 to 70 vol %; and (c) contacting the non-film forming polymer particles and the for-treatment air, wherein the contaminant is extracted from the for-treatment air producing a treated air depleted in the contaminant.

The present invention also provides an air treatment method for removing an odoriferous contaminant, comprising: (a) providing a for-treatment air containing the contaminant, wherein the contaminant comprises at least one of acetaldehyde, d-limonene, an aromatic, a pyridine, a pyrazine, 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene; (b) providing a plurality of non-film forming polymer particles, wherein the non-film forming polymer particles provided are multi-staged particles comprising a core polymer and at least one shell polymer; wherein the core polymer accounts for 1 to 25 wt % of the weight of the non-film forming polymer particles provided; wherein the core polymer comprises, as polymerized monomer units, 90 to 100 wt %, based on weight of the core polymer, of acrylic acid monomer and methacrylic acid monomer; wherein the at least one shell polymer comprises, as polymerized monomer units, 15 to 30 wt %, based on the weight of the at least one shell polymer, of at least one type of multiethylenically unsaturated shell monomer, wherein the at least one type of multiethylenically unsaturated shell monomer is divinyl benzene; and 70 to 85 wt %, based on the weight of the shell polymer, of the at least one type of monoethylenically unsaturated shell monomer, wherein the at least one type of monoethylenically unsaturated shell monomer includes methacrylic acid, methyl methacrylate, butyl methacrylate, sodium styrene sulfonate and styrene; wherein the non-film forming polymer particles provided each contain a central void having an average void fraction of 1 to 70 vol %; and (c) contacting the non-film forming polymer particles and the for-treatment air, wherein the odoriferous contaminant is extracted from the for-treatment air producing a treated air depleted in the contaminant.

The present invention provides an air treatment method for removing a contaminant, comprising: providing a for-treatment air containing the contaminant, wherein the contaminant comprises at least one of acetaldehyde, d-limonene, an aromatic, a pyridine, a pyrazine, 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene; providing a plurality of non-film forming polymer particles, wherein the non-film forming polymer particles provided are multi-staged particles comprising a core polymer and at least one shell polymer; wherein the core polymer accounts for 1 to 25 wt % of the weight of the non-film forming polymer particles provided; wherein the core polymer comprises, as polymerized monomer units, 50 to 100 wt %, based on the weight of the core polymer, of at least one type of monoethylenically unsaturated core monomer containing a single carboxylic acid group; wherein the at least one shell polymer comprises, as polymerized monomer units: 10 to 50 wt %, based on the weight of the at least one shell polymer, of at least one type of multiethylenically unsaturated shell monomer; and 50 to 90 wt %, based on the weight of the at least one shell polymer, of at least one type of monoethylenically unsaturated shell monomer; wherein the non-film forming polymer particles provided each contain a central void, wherein the non-film forming polymer particles provided have an average void fraction of 1 to 70 vol %; providing a semipermeable barrier, wherein the semipermeable barrier impedes passage therethrough by the non-film forming polymer particles and permits passage therethrough by the for-treatment air; and wherein the semipermeable barrier is configured to isolate the plurality of non-film forming polymer particles from an environment containing the for-treatment air; and contacting the non-film forming polymer particles and the for-treatment air, wherein the contaminant is extracted from the for-treatment air producing a treated air depleted in the contaminant.

The present invention provides an air treatment method for removing a contaminant, comprising: providing a for-treatment air containing the contaminant, wherein the contaminant comprises at least one of acetaldehyde, d-limonene, an aromatic, a pyridine, a pyrazine, 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene; providing a plurality of non-film forming polymer particles, wherein the non-film forming polymer particles provided are multi-staged particles comprising a core polymer and at least one shell polymer; wherein the core polymer accounts for 1 to 25 wt % of the weight of the non-film forming polymer particles provided; wherein the core polymer comprises, as polymerized monomer units, 50 to 100 wt %, based on the weight of the core polymer, of at least one type of monoethylenically unsaturated core monomer containing a single carboxylic acid group; wherein the at least one shell polymer comprises, as polymerized monomer units: 10 to 50 wt %, based on the weight of the at least one shell polymer, of at least one type of multiethylenically unsaturated shell monomer; and 50 to 90 wt %, based on the weight of the at least one shell polymer, of at least one type of monoethylenically unsaturated shell monomer; wherein the non-film forming polymer particles provided each contain a central void, wherein the non-film forming polymer particles provided have an average void fraction of 1 to 70 vol %; providing a semipermeable barrier, wherein the semipermeable barrier impedes passage therethrough by the non-film forming polymer particles and permits passage therethrough by the for-treatment air and wherein the semipermeable barrier is configured to isolate the plurality of non-film forming polymer particles from an environment containing the for-treatment air; providing a mover; contacting the non-film forming polymer particles and the for-treatment air, wherein the contaminant is extracted from the for-treatment air producing a treated air depleted in the contaminant; and wherein the mover is configured to motivate the contacting of the for-treatment air and the non-film forming polymer particles.

### DETAILED DESCRIPTION

We have surprisingly found that hollow core non-film forming latex styrene/acrylic copolymer particles exhibit exceptional contaminant scavenging ability for extracting contaminants from indoor air, in particular, the ability to extract odoriferous volatile contaminants (both VOCs and mVOCs), for example, the odoriferous volatile contaminants associated with cigarette smoke.

As used herein, all percentages referred to will be expressed in weight percent (wt %), based on the weight of polymer or composition involved, unless specified otherwise.

As used herein, the term “(meth)acrylic” refers to either (or both) acrylic acid and methacrylic acid.

As used herein, the term “alkyl (meth)acrylate” refers to either (or both) the corresponding alkyl acrylate or alkyl methacrylate.

As used herein, the term “copolymer” or “copolymer material” refers to polymer compositions containing monomer residues of at least two different types of monomer.

As used herein, the terms “sheath” and “shell” are synonymous and refer to the shell polymer composition (not including the core polymer) prepared from single or multistage polymerizations.

The term “polymer” as used herein and in the appended claims refers to a compound prepared by polymerizing monomers, whether of the same or a different type. The generic term “polymer” includes the terms “homopolymer” and “copolymer.”

Preferably, the air treatment method for removing a contaminant of the present invention, comprises: (a) providing a for-treatment air containing the contaminant, wherein the contaminant comprises at least one of acetaldehyde, d-limonene, an aromatic (e.g., benzene, toluene, ethylbenzene, xylene, styrene, trimethylbenzene, propylbenzene), a pyridine (e.g., pyridine, methylpyridine, ethylpyridine, propylpyridine, vinylpyridine), a pyrazine (e.g., pyrazine, methylpyrazine, dimethylpyrazine), 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene (preferably, wherein the contaminant comprises at least one of d-limonene, an aromatic, 3-octanone and 1-butanol; more preferably, wherein the contaminant comprises at least one of d-limonene, ethylbenzene and 3-octanone; most preferably, wherein the contaminant comprises 3-octanone); (b) providing a plurality of non-film forming polymer particles, wherein the non-film forming polymer particles provided are multi-staged particles comprising a core polymer and at least one shell polymer; wherein the core polymer accounts for 1 to 25 wt % (more preferably, 2 to 12 wt %) of the weight of the non-film forming polymer particles provided; wherein the core polymer comprises, as polymerized monomer units, 50 to 100 wt % (preferably, 75 to 100 wt %; more preferably, 90 to 100 wt %; still more preferably, 95 to 100 wt %; most preferably, 99 to 100 wt %), based on the weight of the core polymer, of at least one type of monoethylenically unsaturated core monomer containing a single carboxylic acid group; wherein the at least one shell polymer comprises, as polymerized monomer units: 10 to 50 wt % (preferably, 15 to 35 wt %; more preferably, 15 to 30 wt %; most preferably, 20 to 30 wt %), based on the weight of the at least one shell polymer, of at least one type of multiethylenically unsaturated shell monomer (preferably, wherein the at least one type of multiethylenically unsaturated shell monomer is divinyl benzene); and 50 to 90 wt % (preferably, 65 to 85 wt %; more preferably, 70 to 85 wt %; most preferably, 70 to 80 wt %), based on the weight of the at least one shell polymer, of at least one type of monoethylenically unsaturated shell monomer; wherein the non-film forming polymer particles provided each contain a central void, wherein the non-film forming polymer particles provided have an average void fraction of 1 to 70 vol % (more preferably, 5 to 50 vol %, still more preferably, 10 to 40 vol %; most preferably, 20 to 35 vol %); and (c) contacting the non-film forming polymer particles and the for-treatment air, wherein the contaminant is extracted from the for-treatment air producing a treated air depleted in the contaminant (preferably, wherein >70 vol % (more preferably, >80 vol %; still more preferably, >90 vol %; most preferably, >99 vol %) of the contaminant is extracted from the for-treatment air).

Preferably, in the air treatment method of the present invention, the for-treatment air provided contains a contaminant, wherein the contaminant is at least one of a volatile organic compound (VOC) and a microbial volatile organic compound (mVOC). More preferably, in the air treatment method of the present invention, the for-treatment air provided contains a contaminant, wherein the contaminant is an odoriferous contaminant. Yet more preferably, in the air treatment method of the present invention, the for-treatment air provided contains a contaminant, wherein the contaminant comprises at least one of acetaldehyde, d-limonene, an aromatic (e.g., benzene, toluene, ethylbenzene, xylene, styrene, trimethylbenzene, propylbenzene), a pyridine (e.g., pyridine, methylpyridine, ethylpyridine, propylpyridine, vinylpyridine), a pyrazine (e.g., pyrazine, methylpyrazine, dimethylpyrazine), 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene. Still more preferably, in the air treatment method of the present invention, the for-treatment air provided contains a contaminant selected from the group consisting of at least one of d-limonene, an aromatic, 3-octanone and 1-butanol. Still yet more preferably, in the air treatment method of the present invention, the for-treatment air provided contains a contaminant selected from the group consisting of at least one of d-limonene, ethylbenzene and 3-octanone. Most preferably, in the air treatment method of the present invention, the for-treatment air provided contains 3-octanone. It is believed that some of the key malodor contaminants present in cigarette smoke include acetaldehyde, aromatics, pyradines and pyrazines.

Preferably, in the air treatment method of the present invention, the non-film forming polymer particles provided are multi-staged particles each comprising a core polymer and at least one shell polymer. More preferably, in the air treatment method of the present invention, each particle in the plurality of non-film forming polymer particles provided is a multi-staged particle comprising a core polymer and at least one shell polymer; wherein the core polymer accounts for an average of 1 to 25 wt % (more preferably, 2 to 12 wt %) of each particle in the plurality of the non-film forming polymer particles.

Preferably, the core polymer of the non-film forming polymer particles includes, as polymerized monomer units, 50 to 100 wt %, based on the weight of the core polymer, of at least one type of monoethylenically unsaturated core monomer containing a single carboxylic acid group. More preferably, the core polymer of the non-film forming polymer particles includes, as polymerized monomer units, 75 to 100 wt %, based on the weight of the core polymer, of at least one type of monoethylenically unsaturated core monomer containing a single carboxylic acid group. Still more preferably, the core polymer of the non-film forming polymer particles includes, as polymerized monomer units, 90 to 100 wt %, based on the weight of the core polymer, of at least one type of monoethylenically unsaturated core monomer containing a single carboxylic acid group. Yet still more preferably, the core polymer of the non-film forming polymer particles includes, as polymerized monomer units, 95 to 100 wt %, based on the weight of the core polymer, of at least one type of monoethylenically unsaturated core monomer containing a single carboxylic acid group. Most preferably, the core polymer of the non-film forming polymer particles includes, as polymerized monomer units, 99 to 100 wt %, based on the weight of the core polymer, of at least one type of monoethylenically unsaturated core monomer containing a single carboxylic acid group.

Preferably, the core polymer is obtained by the emulsion homopolymerization of the monoethylenically unsaturated core monomer containing a single carboxylic acid group or by copolymerization of at least two different types of monoethylenically unsaturated core monomers containing a single carboxylic acid group.

Preferably, the monoethylenically unsaturated core monomer containing a single carboxylic acid group is selected from the group of core monomers consisting of acrylic acid, methacrylic acid, (meth)acryloxypropionic acid, crotonic acid, monomethyl maleate, monomethyl fumarate, and monomethyl itaconate. More preferably, the monoethylenically unsaturated core monomer containing a single carboxylic acid is selected from the group of core monomers consisting of acrylic acid and methacrylic acid. Most preferably, the monoethylenically unsaturated core monomer containing a single carboxylic acid is a mixture of acrylic acid monomer and methacrylic acid monomer.

Preferably, the core polymer contains, as polymerized monomer units, <1 wt %, based on the weight of the core polymer, of multiethylenically unsaturated core monomer. More preferably, the core polymer contains, as polymerized monomer units, <0.1 wt %, based on the weight of the core polymer, of multiethylenically unsaturated core monomer. Still more preferably, the core polymer contains, as polymerized monomer units, <0.01 wt %, based on the weight of the core polymer, of multiethylenically unsaturated core monomer. Most preferably, the core polymer contains, as polymerized monomer units, <the detectable limit of multiethylenically unsaturated core monomer.

Preferably, the types of monomer used in the emulsion polymerization to form the shell polymer of the plurality of non-film forming polymer particles provided in the air treatment method of the present invention, are selected from the group consisting of non-ionic ethylenically unsaturated monomers.

Preferably, the types of monomer used in the emulsion polymerization to form the shell polymer of the plurality of non-film forming polymer particles provided in the air treatment method of the present invention, include 10 to 50 wt % (preferably, 15 to 35 wt %; more preferably, 15 to 30 wt %; most preferably, 20 to 30 wt %), based on the weight of the shell polymer, of at least one type of multiethylenically unsaturated shell monomer; and 50 to 90 wt % (preferably, 65 to 85 wt %; more preferably, 70 to 85 wt %; most preferably, 70 to 80 wt %), based on the weight of the shell polymer, of at least one type of monoethylenically unsaturated shell monomer.

Preferably, the at least one multiethylenically unsaturated shell monomer used to form the shell polymer include poly vinylic monomers consisting of at least one of diethyleneglycol divinyl ether, divinyl benzene, divinyl ketone, divinyl pyridine, divinyl sulfide, divinyl sulfone, divinyl toluene, divinyl xylene. More preferably, the at least one multiethylenically unsaturated shell monomer used to form the shell polymer includes divinyl benzene. Most preferably, the at least one multiethylenically unsaturated shell monomer used to form the shell polymer is divinyl benzene.

Preferably, the shell polymer of the plurality of non-film forming latex particles provided in the air treatment method of the present invention comprises, as polymerized monomer units, 10 to 50 wt % (preferably, 15 to 35 wt %; more preferably, 15 to 30 wt %; most preferably, 20 to 30 wt %), based on the weight of the shell polymer, of at least one type of multiethylenically unsaturated shell monomer selected from the group consisting of diethyleneglycol divinyl ether, divinyl benzene, divinyl ketone, divinyl pyridine, divinyl sulfide, divinyl sulfone, divinyl toluene and divinyl xylene. More preferably, the shell polymer of the plurality of non-film forming latex particles provided in the air treatment method of the present invention comprises, as polymerized monomer units, 10 to 50 wt % (preferably, 15 to 35 wt %; more preferably, 15 to 30 wt %; most preferably, 20 to 30 wt %), based on the weight of the shell polymer, of at least one type of multiethylenically unsaturated shell monomer includes divinyl benzene. Most preferably, the shell polymer of the plurality of non-film forming latex particles provided in the air treatment method of the present invention comprises, as polymerized monomer units, 10 to 50 wt % (preferably, 15 to 35 wt %; more preferably, 15 to 30 wt %; most preferably, 20 to 30 wt %), based on the weight of the shell polymer, of divinyl benzene.

Preferably, the shell polymer of the plurality of non-film forming latex particles provided in the air treatment method of the present invention comprises, as polymerized monomer units, <10 wt %, based on the weight of the shell polymer, of tri or higher methacrylate monomers. More preferably, the shell polymer of the plurality of non-film forming latex particles provided in the air treatment method of the present invention comprises, as polymerized monomer units, <1 wt %, based on the weight of the shell polymer, of tri or higher methacrylate monomers. Still more preferably, the shell polymer of the plurality of non-film forming latex particles provided in the air treatment method of the present invention comprises, as polymerized monomer units, <0.1 wt %, based on the weight of the shell polymer, of tri or higher methacrylate monomers. Most preferably, the shell polymer of the plurality of non-film forming latex particles provided in the air treatment method of the present invention comprises, as polymerized monomer units, less than the detectable limit of tri or higher methacrylate monomers.

Preferably, the at least one monoethylenically unsaturated shell monomer used to form the shell polymer is selected from the group consisting monoethylenically unsaturated shell monomers containing at least one carboxylic acid group; monoethylenically unsaturated shell monomers containing at least one non-carboxylic acid group; and monoethylenically unsaturated vinyl aromatic shell monomers.

Preferred monoethylenically unsaturated shell monomers containing at least one carboxylic acid group include, for example, acrylic acid, methacrylic acid, acryloxypropionic acid, methacryloxypropionic acid, aconitic acid, crotonic acid, maleic acid (and derivatives such as corresponding anhydride, amides and esters), fumaric acid (and derivatives such as corresponding amides and esters), itaconic and citraconic acids (and derivatives such as corresponding anhydrides, amides and esters). More preferred monoethylenically unsaturated shell monomers containing at least one carboxylic acid group are methacrylic acid and C₁₋₄ alkyl (meth)acrylate. Most preferred monoethylenically unsaturated shell monomers containing at least one carboxylic acid group are methacrylic acid, methyl methacrylate and butyl methacrylate.

Preferably, the shell polymer of the plurality of non-film forming latex particles provided in the air treatment method of the present invention comprises, as polymerized monomer units, 50 to 90 wt % (more preferably, 10 to 80 wt %; still more preferably, 15 to 70 wt %; most preferably, 20 to 30 wt %), based on the weight of the shell polymer, of monoethylenically unsaturated shell monomers containing at least one carboxylic acid group selected from the group consisting of at least one of methacrylic acid, methyl acrylate, methyl methacrylate, ethyl acrylate, ethyl methacrylate, butyl acrylate, butyl methacrylate, isobutyl acrylate, isobutyl methacrylate, hydroxyethyl methacrylate, hydroxypropyl methacrylate, dimethylaminoethyl methacrylate. More preferably, the shell polymer of the plurality of non-film forming latex particles provided in the air treatment method of the present invention comprises, as polymerized monomer units, 50 to 90 wt % (more preferably, 10 to 80 wt %; still more preferably, 15 to 70 wt %; most preferably, 20 to 30 wt %), based on the weight of the shell polymer, of monoethylenically unsaturated shell monomers containing at least one carboxylic acid group selected from the group consisting of at least one of methacrylic acid, methyl methacrylate and butyl methacrylate. Most preferably, the shell polymer of the plurality of non-film forming latex particles provided in the air treatment method of the present invention includes, as polymerized monomer units, 50 to 90 wt % (more preferably, 10 to 80 wt %; still more preferably, 15 to 70 wt %; most preferably, 20 to 30 wt %), based on the weight of the shell polymer, of methacrylic acid, methyl methacrylate and butyl methacrylate.

Preferred monoethylenically unsaturated shell monomers containing at least one non-carboxylic acid group include, for example, allyl sulfonic acid, allylphosphonic acid, allyloxybenzene sulfonic acid, 2-acrylamido-2-methylpropanesulfonic acid, 2-hydroxy-3(2-propenyloxy) propanesulfonic acid, 2-methyl-2-propene-1-sulfonic acid, 2-methacrylamido-2-methyl-1-propane sulfonic acid, 3-methacrylamido-2-hydroxy-1-propanesulfonic acid, isopropenylphosphonic acid, vinyl phosphonic acid, styrene sulfonic acid, vinylsulfonic acid and the alkali metal and ammonium salts thereof. More preferred monoethylenically unsaturated shell monomers containing non-carboxylic acid are 2-acrylamido-2-methyl propanesulfonic acid, styrenesulfonic acid and the alkali metal salts thereof. Most preferred monoethylenically unsaturated shell monomer containing non-carboxylic acid is sodium styrene sulfonate.

Preferably, the shell polymer of the plurality of non-film forming latex particles provided in the air treatment method of the present invention comprises, as polymerized monomer units, 0 to 10 wt % (more preferably, 0.1 to 5 wt %; most preferably, 0.5 to 3 wt %), based on the weight of the shell polymer, of monoethylenically unsaturated shell monomers containing at least one non-carboxylic acid group selected from the group consisting of at least one of allyl sulfonic acid, allylphosphonic acid, allyloxybenzene sulfonic acid, 2-acrylamido-2-methylpropanesulfonic acid, 2-hydroxy-3(2-propenyloxy) propanesulfonic acid, 2-methyl-2-propene-1-sulfonic acid, 2-methacrylamido-2-methyl-1-propane sulfonic acid, 3-methacrylamido-2-hydroxy-1-propanesulfonic acid, isopropenylphosphonic acid, vinyl phosphonic acid, styrene sulfonic acid, vinylsulfonic acid and the alkali metal and ammonium salts thereof. More preferably, the shell polymer of the plurality of non-film forming latex particles provided in the air treatment method of the present invention comprises, as polymerized monomer units, 0 to 10 wt % (more preferably, 0.1 to 5 wt %; most preferably, 0.5 to 3 wt %), based on the weight of the shell polymer, of monoethylenically unsaturated shell monomers containing at least one non-carboxylic acid group selected from the group consisting of at least one of 2-acrylamido-2-methyl propanesulfonic acid, styrenesulfonic acid and the alkali metal salts thereof. Most preferably, the shell polymer of the plurality of non-film forming latex particles provided in the air treatment method of the present invention comprises, as polymerized monomer units, 0 to 10 wt % (more preferably, 0.1 to 5 wt %; most preferably, 0.5 to 3 wt %), based on the weight of the shell polymer, of sodium styrene sulfonate.

Preferred monoethylenically unsaturated vinyl aromatic shell monomers include, for example, styrene, α-methylstyrene, vinyltoluene, alkyl-substituted styrene (e.g., ethylvinylbenzene and tert-butylstyrene) and halogenated styrenes. More preferred monoethylenically unsaturated vinyl aromatic shell monomers are selected from the group consisting of styrene, ethyl vinyl benzene and tert-butylstyrene. The most preferred monoethylenically unsaturated vinyl aromatic shell monomer is styrene.

Preferably, the shell polymer of the plurality of non-film forming latex particles provided in the air treatment method of the present invention comprises, as polymerized monomer units, 10 to 80 wt % (more preferably, 25 to 70 wt %; most preferably, 30 to 60 wt %), based on the weight of the shell polymer, of monoethylenically unsaturated vinyl aromatic shell monomers selected from the group consisting of styrene, α-methylstyrene, vinyltoluene, alkyl-substituted styrene (e.g., ethylvinylbenzene and tert-butylstyrene) and halogenated styrenes. More preferably, the shell polymer of the plurality of non-film forming latex particles provided in the air treatment method of the present invention comprises, as polymerized monomer units, 10 to 80 wt % (more preferably, 25 to 70 wt %; most preferably, 30 to 60 wt %), based on the weight of the shell polymer, of monoethylenically unsaturated vinyl aromatic shell monomers selected from the group consisting of styrene, ethyl vinyl benzene and tert-butylstyrene.

Most preferably, the shell polymer of the plurality of non-film forming latex particles provided in the air treatment method of the present invention comprises, as polymerized monomer units, 10 to 80 wt % (more preferably, 25 to 70 wt %; most preferably, 30 to 60 wt %), based on the weight of the shell polymer, of styrene.

Preferably, the monomers that comprise the shell polymer of the plurality of non-film forming polymer particles provided in the air treatment method of the present invention are selected to provide a glass transition temperature (T_{g}) in at least one shell which is high enough to support the void within the latex particle. Preferably the T_{g} of at least one shell is >50° C. (more preferably, >60° C.; most preferably, >70° C.), as measured by differential scanning calorimetry (DSC).

Preferably, the amount of polymer deposited to form the shell polymer is sufficient to provide the plurality of non-film forming polymer particles with an average particle size of 50 to 1,000 nm, as measured using a Brookhaven BI-90 photon correlation spectrometer. More preferably, the amount of polymer deposited to form the shell polymer is sufficient to provide the plurality of non-film forming polymer particles with an average particle size of 100 to 600 nm, as measured using a Brookhaven BI-90 photon correlation spectrometer. Still more preferably, the amount of polymer deposited to form the shell polymer is sufficient to provide the plurality of non-film forming polymer particles with an average particle size of 200 to 500 nm, as measured using a Brookhaven BI-90 photon correlation spectrometer. Most preferably, the amount of polymer deposited to form the shell polymer is sufficient to provide the plurality of non-film forming polymer particles with an average particle size of 300 to 400 nm, as measured using a Brookhaven BI-90 photon correlation spectrometer.

Preferably, each particle in the plurality of non-film forming polymer particles provided in the air treatment method of the present invention contains a void. Preferably, the void contained by each particle in the plurality of the non-film forming polymer particles provided in the air treatment method of the present invention is preferably formed through swelling of the core with an aqueous basic swellant that permeates the shell and expands the core. This expansion may involve partial merging of the outer periphery of the core into the pores of the inner periphery of the shell and also partial enlargement or bulging of the shell and the entire particle overall. When the swellant is removed by drying, the shrinkage of the core develops a microvoid, the extent of which depends on the resistance of the shell to restoration to its previous size. Suitable swelling agents for the core include, for example, ammonia, ammonium hydroxide, alkali metal hydroxides (such as sodium hydroxide), and volatile lower aliphatic amines (such as trimethylamine and triethylamine). The swelling step may occur during any of the multistage shell polymerization steps, between any of the staged polymerization steps, or at the end of the multistage polymerization process.

Preferably, each particle in the plurality of non-film forming polymer particles provided in the air treatment method of the present invention, contains a void, wherein the average void fraction for the plurality of non-film forming polymer particles provided is 1 to 70 vol %; more preferably, 5 to 50 vol %, still more preferably, 10 to 40 vol %; most preferably, 20 to 35 vol %. The void fraction is determined by comparing the volume occupied by a plurality of non-film forming polymer particles after compaction from a dilute dispersion in a centrifuge to the volume of an equivalent population of non-voided polymer particles having the same composition.

Preferably, the non-film forming polymer particles provided in the air treatment method of the present invention are hollow core polymer particles which each contain a single central void.

Preferably, the non-film forming polymer particles provided in the air treatment method of the present invention contain, as polymerized monomer units, <10 wt % alkyl acrylate monomer. More preferably, the non-film forming polymer particles provided in the air treatment method of the present invention contain, as polymerized monomer units, <1 wt % alkyl acrylate monomer. Still more preferably, the non-film forming polymer particles provided in the air treatment method of the present invention contain, as polymerized monomer units, <0.1 wt % alkyl acrylate monomer. Most preferably, the non-film forming polymer particles provided in the air treatment method of the present invention contain, as polymerized monomer units, less than the detectable limit of alkyl acrylate monomer.

Preferably, the non-film forming polymer particles provided in the air treatment method of the present invention contain <5 wt % water. More preferably, the non-film forming polymer particles provided in the air treatment method of the present invention contain <3 wt % water. Still more preferably, the non-film forming polymer particles provided in the air treatment method of the present invention contain <2 wt % water. Yet more preferably, the non-film forming polymer particles provided in the air treatment method of the present invention contain <1 wt % water. Most preferably, the non-film forming polymer particles provided in the air treatment method of the present invention are dry.

Preferably, the air treatment method of the present invention further comprises providing a semipermeable barrier, wherein the semipermeable barrier impedes passage therethrough by the non-film forming polymer particles and permits passage therethrough by the for-treatment air; and wherein the semipermeable barrier is configured to isolate the plurality of non-film forming polymer particles from an environment containing the for-treatment air. Preferably, the semipermeable barrier provided is selected from the group consisting of at least one of a screen, a mesh, a woven or non-woven substrate, an expanded metal and a membrane.

Preferably, the air treatment method of the present invention further comprises providing a mover, wherein the mover is configured to motivate the contacting of the for-treatment air and the non-film forming polymer particles. Preferably, the mover provided is selected from the group consisting of a fan or a pump. Preferably, the mover provided is part of an HVAC system.

Preferably, the plurality of non-film forming polymer particles provided in the air treatment method of the present invention are provided as a free flowing powder. More preferably, the plurality of non-film forming polymer particles provided in the air treatment method of the present invention are provided as a free flowing powder, wherein the contacting of the non-film forming polymer particles and the for-treatment air form a fluidized bed of the non-film forming polymer particles.

Preferably, the plurality of non-film forming polymer particles provided in the air treatment method of the present invention are provided in a packed bed configuration. More preferably, the plurality of non-film forming polymer particles provided in the air treatment method of the present invention are disposed between a plurality of semipermeable barriers.

Some embodiments of the present invention will now be described in detail in the following Examples.

### Comparative Examples C1-C9 and Examples 1-4, 5a-5d and 6-9: Contaminant Abatement

The following contaminant analyte abatement experiments were performed by equilibrium headspace GC-MS VOC analysis with an Agilent 6890GC with 5973 MS detector and a Perkin Elmer TurboMatrix 40 Trap Headspace Sampler using the following instrument parameters:
Column: Model No. J&W 122-7033 DB-Wax column (30 m×0.25 mm×0.5 μm); constant flow mode; 11.37 psi nominal inlet pressure; 25 cm/sec average velocity; helium gas.
Inlet conditions: split mode; 200° C.; 11.36 psi; 0.2:1 split ratio; 0.2 mL/min split flow; 3.9 mL/min total flow.
Oven program: 40° C. initial temperature with a 5 min. hold; 20° C./min linear temperature ramp; 250° C. final temperature with a 9.0 min. hold; 24.50 min. total run time.
Mass detector: SCAN acquisition mode; 1494.1 resulting EM voltage; 28.0 low mass; 200.0 high mass; 150° C. quad temp.; 230° C. source temp.
Headspace autosampler parameters: 35° C. (equilibrium)/150° C. (bulk) oven temperature; 60° C. (equilibrium)/175° C. (bulk) needle temperature; 100° C. (equilibrium)/200° C. (bulk) transfer line temperature; 10 min. vial equilibrium time; 2.0 min pressurization time; 0.1 min. injection time; 35 min. GC cycle time; 25 psi carrier pressure; operating mode: constant; injection mode: time.

A set of standards of known concentrations were prepared for each of the contaminant analytes tested in tetrahydrofuran (THF). The standards were run under high temperature headspace conditions (150° C., 10 min.) to provide full liberation of the contaminant analytes into the headspace of 22 mL headspace vials. The weight concentrations were converted to ppm volume/volume (v/v) concentrations using the ideal gas law. The calibration range used encompassed 10 to 1,000 ppm (v/v).

Comparative Examples (controls) were prepared by dispensing a certain volume (5 mL) of the headspace of a 22 mL headspace vial containing about 5 grams of the noted contaminant analytes into an empty 22 mL headspace vial and quickly capping with a Teflon lined septum. The contaminant 1-butanol analytes were done with 0.5 and 5 mL spikes.

The Examples were prepared by adding the same volume of the noted contaminant that was added to the controls to an empty 22 mL headspace vial already containing the mass noted in TABLE 1 of the plurality of non-film forming polymer particles (“Particles”) (a styrene/acrylate, volatile base-swollen, crosslinked hollow sphere polymer powder available from The Dow Chemical Company as SunSpheres™ powder).

The Comparative Examples (controls) and the Examples were run via headspace GC-MS near room temperature (35° C., 10 min) and then the headspace of each was injected into the hot inlet of the GC-MS with the instrument settings noted above (about 2 hours after dispensing the noted contaminant analytes into the vials). The ppm volume/volume (v/v) concentration of the noted contaminant analytes in the headspace of each Comparative Example (control) and Example was then determined using the linear-least-squares equation from the calibration plot for the subject contaminant analyte (peak area vs. v/v concentration). The abatement performance of the Particles was calculated as the percent of contaminant analyte extracted by the Particles in the Example vials versus the Comparative Example (controls). The results are reported in TABLE 1.

TABLE 1

| | | Analyte | | |
|---|---|---|---|---|
| Ex. | Particles (mg) | Contaminant | ppm (v/v) | Abatement (%) |
| C1 | — | 3-octanone | 130 | — |
| 1 | 13.00 | 3-octanone | 3 | 97.7 |
| C2 | — | 3-octanone | 127 | — |
| 2 | 10.01 | 3-octanone | 6 | 96.0 |
| C3 | — | 3-octanone | 193 | — |
| 3 | 50.84 | 3-octanone | 0.5 | 99.7 |
| C4 | — | 3-octanone | 137 | — |
| 4 | 49.21 | 3-octanone | 0.5 | 99.6 |
| C5 | — | d-limonene | 121 | — |
| 5a | 10.11 | d-limonene | 72 | 40.2 |
| 5b | 10.23 | d-limonene | 57 | 52.6 |
| 5c | 49.5 | d-limonene | 18 | 85.2 |
| 5d | 52.87 | d-limonene | 16 | 86.6 |
| C6 | — | 1-butanol | 220 | — |
| 6 | 9.8 | 1-butanol | 82 | 56.8 |
| C7 | — | 1-butanol | 158 | — |
| 7 | 50.5 | 1-butanol | 22 | 88.3 |
| C8 | — | 1-butanol | 37 | — |
| 8 | 10 | 1-butanol | 11 | 72.8 |
| C9 | — | 1-butanol | 43 | — |
| 9 | 50.5 | 1-butanol | 3 | 91.6 |

We claim:

1. An air treatment method for removing a contaminant, comprising:
(a) providing a for-treatment air containing the contaminant, wherein the contaminant comprises at least one of acetaldehyde, d-limonene, an aromatic, a pyridine, a pyrazine, 1-octen-3-ol, 3-methylfuran, 2-pentanol, 2-hexanone, 2-heptanone, 3-octanone, 3-octanol, trans-2-octen-1-ol, cis-2-octen-1-ol, 1-octene, 2-pentanone, 2-nonanone, borneol, geosmin, 1-butanol, 3-methyl-1-butanol, 3-methyl-2-butanol and thujopsene;
(b) providing a plurality of non-film forming polymer particles,
wherein the non-film forming polymer particles provided are multi-staged particles comprising a core polymer and at least one shell polymer;
wherein the core polymer accounts for 1 to 25 wt % of the weight of the non-film forming polymer particles provided;
wherein the core polymer comprises, as polymerized monomer units, 50 to 100 wt %, based on the weight of the core polymer, of at least one type of monoethylenically unsaturated core monomer containing a single carboxylic acid group;
wherein the at least one shell polymer comprises, as polymerized monomer units:
10 to 50 wt %, based on the weight of the at least one shell polymer, of at least one type of multiethylenically unsaturated shell monomer; and
50 to 90 wt %, based on the weight of the at least one shell polymer, of at least one type of monoethylenically unsaturated shell monomer;
wherein the non-film forming polymer particles provided each contain a central void, wherein the non-film forming polymer particles provided have an average void fraction of 1 to 70 vol %; and
(c) contacting the non-film forming polymer particles and the for-treatment air, wherein the contaminant is extracted from the for-treatment air producing a treated air depleted in the contaminant.

2. The air treatment method of claim 1, wherein the at least one type of monoethylenically unsaturated core monomer is selected from the group consisting of acrylic acid monomer and methacrylic acid monomer.

3. The air treatment method of claim 2, wherein the core polymer comprises, as polymerized monomer units, 90 to 100 wt %, based on weight of the core polymer, of the acrylic acid monomer and methacrylic acid monomer.

4. The air treatment method of claim 1, wherein the at least one type of multiethylenically unsaturated shell monomer is divinyl benzene.

5. The air treatment method of claim 2, wherein the at least one type of multiethylenically unsaturated shell monomer is divinyl benzene.

6. The air treatment method of claim 3, wherein the at least one shell polymer comprises, as polymerized monomer units, 15 to 30 wt %, based on the weight of the at least one shell polymer, of the at least one type of multiethylenically unsaturated shell monomer; wherein the at least one type of multiethylenically unsaturated shell monomer is divinyl benzene.

7. The air treatment method of claim 4, wherein the at least one type of monoethylenically unsaturated shell monomer includes: at least one monoethylenically unsaturated shell monomer containing at least one carboxylic acid group; at least one monoethylenically unsaturated shell monomer containing at least one non-carboxylic acid group; and at least one monoethylenically unsaturated vinyl aromatic shell monomer.

8. The air treatment method of claim 6, wherein the at least one shell polymer comprises, as polymerized monomer units 70 to 85 wt %, based on the weight of the at least one shell polymer, of the at least one type of monoethylenically unsaturated shell monomer; wherein the at least one type of monoethylenically unsaturated shell monomer includes methacrylic acid, methyl methacrylate, butyl methacrylate, sodium styrene sulfonate and styrene.

9. The air treatment method of claim 1, further comprising:
providing a semipermeable barrier, wherein the semipermeable barrier impedes passage therethrough by the non-film forming polymer particles and permits passage therethrough by the for-treatment air; and
wherein the semipermeable barrier is configured to isolate the plurality of non-film forming polymer particles from an environment containing the for-treatment air.

10. The air treatment method of claim 9, further comprising:
providing a mover, wherein the mover is configured to motivate the contacting of the for-treatment air and the non-film forming polymer particles.
